(19) United States
(12) Patent Application Publication
(10) Pub. No.: US 2021/0310599 A1
(43) Pub. Date: Oct. 7, 2021

(54) METHOD FOR INSULATING A PROCESS UNIT AND PROCESS UNIT HAVING AN INSULATING REGION

(71) Applicants: Synhelion SA, Lugano (CH); ENI S.P.A., Rome (IT)

(72) Inventors: Gianluca AMBROSETTI, Gintilino (CH); Philipp GOOD, Zurich (CH)

(21) Appl. No.: 17/262,024

(22) PCT Filed: Jul. 23, 2019
(86) PCT No.: PCT/CH2019/050014

§ 371 Date: Jan. 21, 2021

(30) Foreign Application Priority Data
Jul. 27, 2018 (CH) 00932/18

(51) Int. Cl. F16L 59/02; F24S 80/60; F24S 20/20; F24S 80/20; F24S 40/55; F24S 80/40

(52) U.S. Cl. CPC F16L 59/029; F24S 80/60; F24S 80/40; F24S 80/20; F24S 40/55; F24S 20/20

(57) ABSTRACT

The invention relates to a method for insulating a process unit, which is provided with an insulating region (17, 41) for curbing the flow of heat from a hot side to a cold side of the insulating region (17, 41), the insulating region being cooled at a point with a temperature that is lower Man the temperature of the hot side, the heat absorbed by a cooling medium being transported out of the insulating region and being supplied as recovered heat to a consumer of heat.

The present invention relates to a method according to the preamble of claim 1 and to a process unit according to the preamble of claim 7.

The insulation of process units, in particular of those in which high temperatures prevail, is frequently related to complex issues. For example, in the case of solar receivers—called “receivers” in the following—a satisfactory insulation is difficult to achieve inter alia because a satisfactory insulation generally has a large mass with a correspondingly high thermal inertia; as a result, although little heat is lost during the operation of the receiver, the amount of heat stored in the insulation is lost during the unavoidable interruptions in operation (night, bad weather, etc.) and is re-absorbed by the insulation when operation is resumed. This noticeably reduces the overall efficiency of the receiver in spite of a good insulation.

For example, insulation consisting of radiation-shielding sheets staggered one behind the other would in principle be a very good solution in this context with regard to heat losses and thermal inertia; it is, however, too expensive for industrial production and, moreover, difficult to construct in cases where the area to be insulated has a complicated shape.

A further problem is that high-temperature insulation materials suitable for high operating temperatures such as, e.g., above 1000° C., often have a higher thermal conductivity coefficient λ compared to materials with a lower operating temperature—i.e. high-temperature insulation materials insulate relatively poorly compared to the high-performance insulation materials that can be used at lower temperatures. The combination of high-temperature insulation materials with high-performance insulation materials is known in the prior art. In this case, the high-temperature insulation material (which has the higher thermal conductivity coefficient λ) is arranged first, in the direction of the heat flow Q, before the high-performance insulation material with the lower thermal conductivity coefficient λ, which is arranged toward the cold side of the insulation.

As a result of the temperature drop occurring during operation in the insulation in the direction of the heat flow Q, the temperature in the high-temperature insulation material falls after a certain thickness to a level that is compatible with the high-performance insulation material, so that it is possible to arrange this better-insulating material at this location.

However, such an arrangement has the disadvantage that, in the event of an inappropriate dimensioning, the temperature drop in the high-temperature insulation material decreases in the course of operation, i.e. the temperature increases at the transition to the high-performance insulation material and rises above the operating temperature of the same. As a result, if the dimensions are correct, the high-performance insulation material can only be used to a limited extent so that there is then still a large mass of insulation material with a correspondingly high and undesirable thermal inertia.

The problems described above affect not only receivers, but all possible process units to be insulated in the field of engineering.

It is accordingly the object of the present invention to provide insulation for a process unit with reduced thermal inertia.

To this end, a method according to the invention includes the characterizing features of claim 1 and a process unit insulated according to the invention includes the characterizing features of claim 7.

By cooling the insulating area, the risk of overheating the temperature-sensitive high-performance insulation material can be avoided so that its dimensions can be increased considerably at the expense of the high-temperature insulation material, with the consequence that the total mass of the insulation is accordingly lower, which in turn leads to the desired reduced thermal inertia. By using the heat that results from cooling in a consumer, a reduction of the efficiency of the process unit is avoided.

Preferred embodiments comprise the features of the dependent claims.

The invention is illustrated further in the following with the aid of the drawings, wherein:

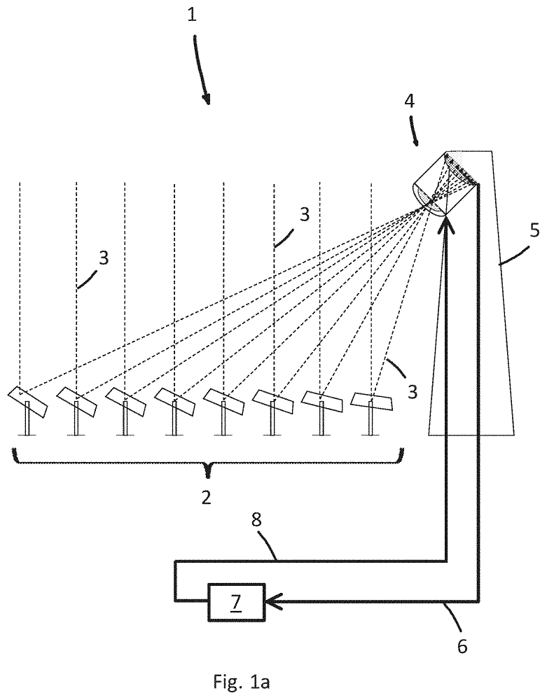

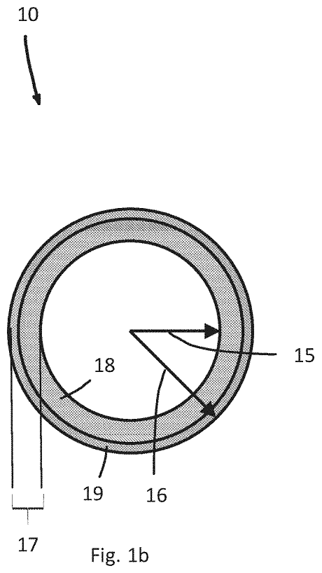

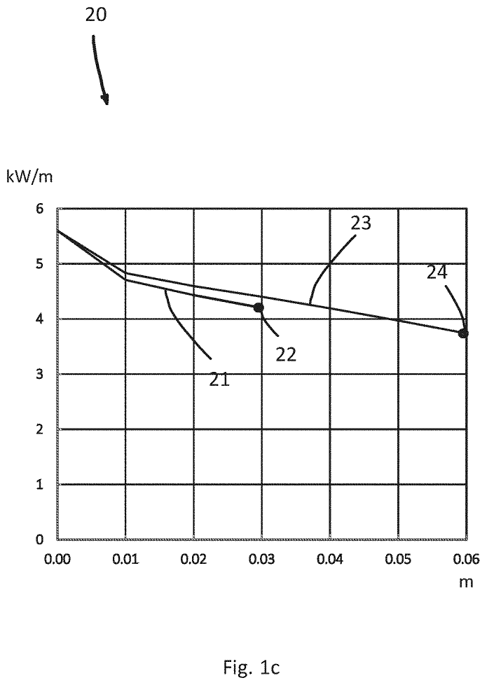

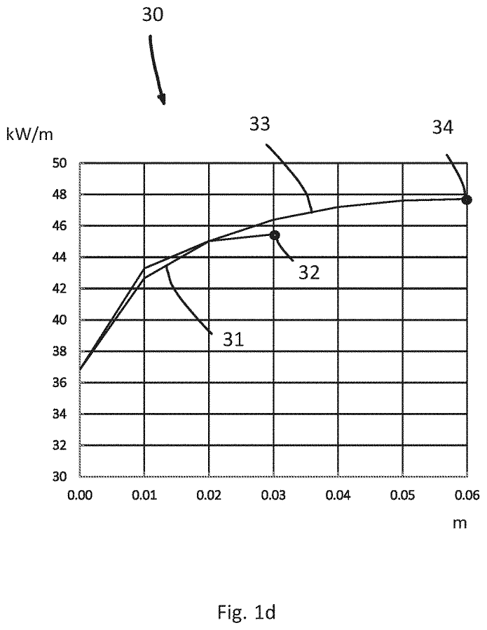

FIG. 1a schematically illustrates a solar tower power plant according to the prior art,

FIG. 1b illustrates a cross-section through a cylindrical section of a process unit insulated according to the prior art, here a model for a receiver of the solar tower power plant according to FIG. 1a,

FIG. 1c illustrates a graph showing the heat losses of the cylindrical section according to FIG. 1b,

FIG. 1d illustrates a graph showing the thermal inertia

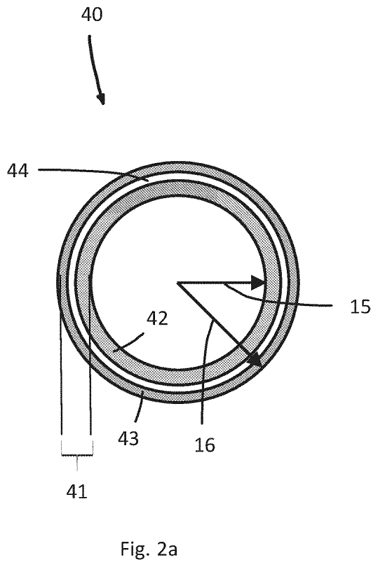

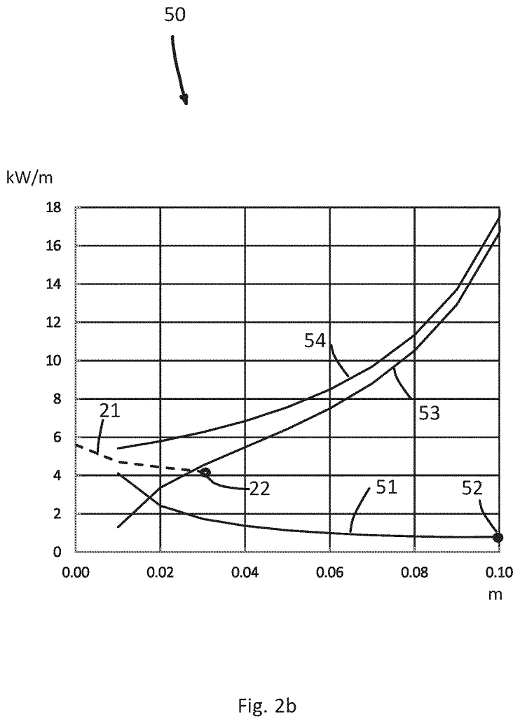

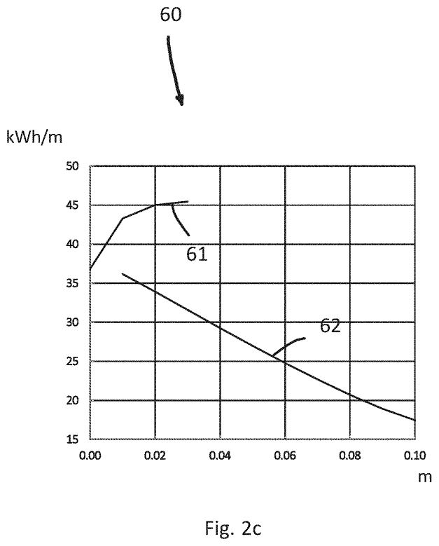

FIG. 2a illustrates a cross-section through a cylindrical section according to FIG. 1a insulated according to the invention,

FIG. 2b shows a graph showing the thermal conditions of the cylindrical section according to FIG. 2a,

FIG. 2c shows a graph showing the thermal inertia of the cylindrical section according to FIG. 2a, and

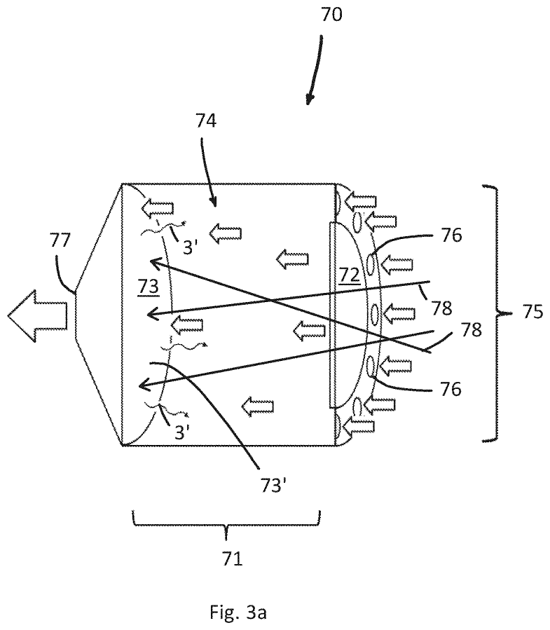

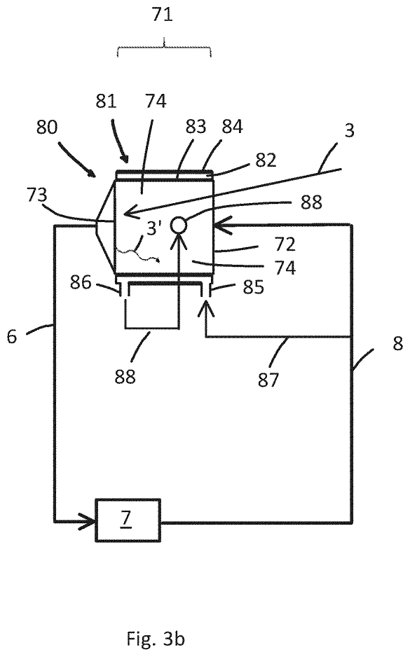

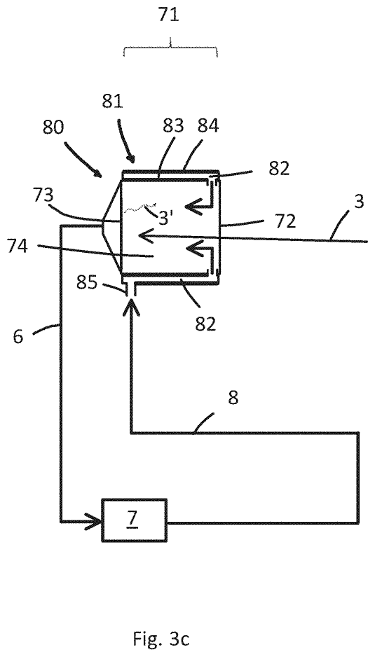

FIG. 3 schematically illustrates a receiver configured for the recirculation of the heated cooling medium.

FIG. 1a schematically shows a solar tower power plant 1, with a field of heliostats 2, which deflect in a known manner rays 3 of the sun in concentrated form onto a receiver 4 according to the invention, which is in turn arranged on a tower 5.

A heat-transporting fluid can be heated by the receiver 4, wherein this (solar) heat is then industrially exploitable, e.g. for the generation of steam in a turbine or for industrial processes that require heat. It is also possible to configure the receiver 4 as a receiver-reactor for the generation of, for example, syngas.

The heat arising in the receiver or receiver-reactor 4—i.e., in the case of the receiver-reactor, the heat that is currently not exploitable or required for the chemical reaction that takes place in it—can be conducted via heated heat-transporting fluid with a (higher) temperature T₀ via a line 6 to a consumer 7, where it cools and is then conducted in the circuit back to the receiver or receiver-reactor 4 via a line 8 with a (lower) temperature Tᵢₙ.

Spatially configured receivers suitable for high temperatures as reached, e.g., at a concentration of 500 suns, 1000 suns or more, are predominantly used in solar tower power plants. These temperatures are generally over 800 K and may reach the range of 1000 K, 1500 K or more in the near future, while it is expected that temperatures of 1800 K or 2000 K will not only be reached, but surpassed very soon, for example, in syngas production.

By their nature, solar power plants cease operation at night, or in the event of bad weather, with the consequence that the in principle well-insulated receiver cools off together with its insulation. Accordingly, when operation is re-initiated, not only the receiver, but also the insulation must first be brought to operating temperature, which, due to the thermal inertia of the considerable mass of the insulation, undesirably costs time and solar energy and can considerably reduce the efficiency of the receiver in relation to its operating time.

As mentioned above, the present invention, although particularly suitable for receivers in solar power plants, can be employed in process engineering wherever insulation is required and, for example, a low thermal inertia is desirable.

FIG. 1b shows a cross-section through a model 10 for a receiver 4 of the solar tower power plant 1 according to FIG. 1a. In terms of its design, a simple embodiment of an absorptive receiver is assumed here, cf. the description regarding FIG. 3 in this regard. The model 10 relates to a section 11 of the receiver 4, i.e. a section of its cylindrical wall XX of the absorption area 74 (see FIG. 3a).

The thermal conditions correspond to an insulation according to the prior art and were calculated by solving the steady-state, one-dimensional heat conduction equation in the radial direction. It is noted that the insulated section of a receiver can also be understood as a model for, for example, an insulated pipe.

The inner radius 15 of the zone with the (high) operating temperature (here 1800 K) is 400 mm, while the outer radius 16 of the insulated area is 550 mm, so that the thickness of the insulating area 17 is 150 mm, wherein the insulating area 17 comprises two layers, namely an inner layer 18 made of a high-temperature insulation material and an outer layer 19 made of a high-performance insulation material, which, however, is not suitable for high temperatures:

In general, insulation materials for high temperatures, here over 1000° C. to 1200° C., have a higher thermal conductivity coefficient λ than insulation materials for lower temperatures and thus generally insulate worse than the latter. A high-temperature insulation material for use above 1000° C. typically has a thermal conductivity coefficient of approx. 0.2 W/(m K) and a density of approx. 450 Kg/m³), while a typical high-performance insulation material may have a thermal conductivity coefficient of approx. 0.03 W/(m K) and a density of approx. 250 Kg/m³), but can only be used up to the range of 1000° C. or 1200° C.

Accordingly, at high operating temperatures, it is necessary to use a high-temperature insulation material, e.g. yttria-stabilized zirconia (as known, for example, under the trade name “Zircar ZYFB-3”), for the inner layer 18 and a high-performance insulation material such as microporous silica (as known, for example, under the trade name “Microtherm 1000R”) or alumina (as known, for example, under the trade name “Microtherm 1200”) for the outer layer. The thickness of the layer 18 made of high-temperature insulation material depends on the temperature drop across its thickness: as soon as the temperature has fallen below 1000° C. to 1200° C., the layer 19 made of high-performance insulation material can be attached. However, the high-performance insulation material is intrinsically limited in terms of its applicability: due to the fact that a lower heat flow (in the sense of a better insulation) flows through the high-performance insulation material in comparison with the high-temperature insulation material, the layer 19 is only provided in a thickness so as to avoid the occurrence of a heat build-up, which would reduce the temperature drop in the layer 18 and thus damage the high-performance insulation material in the course of a longer operation due to the corresponding temperature increase. The resulting necessary thickness of the layer 18 made of high-temperature insulation material undesirably increases the thermal inertia to a considerable extent.

FIG. 1c shows a graph 20, the vertical axis of which shows the heat flow through the insulating area 17 (thickness 150 mm) of the model 10 (FIG. 1b) and the horizontal axis of which shows the thickness of the layer 19 of Microtherm 1000R or Microtherm 1200, assuming that the layer 18 consists of Zircar ZYFB-3.

It is evident from the curve 21 for Microtherm 1000R that a heat loss that is lower than 5.5 kW/m, here 5.5 kW per m of height of the model 10 (FIG. 1b), is achievable, but no lower than approx. 4.2 kW/m, as the curve breaks off at the point 22 because the operating temperature of the Microtherm 1000R would otherwise be exceeded were the layer thickness to be further increased. In the case of Microtherm 1000R, the thickness of the layer 19 can thus not exceed 30 mm, leaving 120 mm for the thickness of the layer 18 made of Zircar ZYFB-3.

It is evident from the curve 23 for Microtherm 1200 that a heat loss that is lower than 5.5 kW/m, here 5.5 kW per m of height of the model 10 (FIG. 1b), is also achievable, but no lower than approx. 3.8 kW/m, as the curve breaks off at the point 24 because the operating temperature of the Microtherm 1200 would otherwise be exceeded were the layer thickness to be further increased. In the case of Microtherm 1200, the thickness of the layer 19 thus cannot exceed 60 mm. There thus remains, at a minimum, a thickness of 90 mm of the layer 18 with the greater mass made of Zircar ZYFB-3, which contributes to the undesired thermal inertia.

FIG. 1d shows a graph 30, the vertical axis of which shows the thermal inertia in kWh/m, here per m of height of the model 10 (FIG. 1b), i.e. the energy, i.e. the amount of heat, required to bring the insulation layer 17 (FIG. 1b) made of Zircar ZYFB-3 with either Microtherm 1000R or Microtherm 1200 from the ambient temperature (here 300 K) to operating temperature. Operating temperature here means that the inner wall of the high-temperature insulation layer 18 made of Zircar ZYFB-3 is at 1800 K and the outer wall of the high-performance insulation material of the layer 19 is surrounded by air at ambient temperature, i.e. 300 K.

The horizontal axis shows the thickness of the layer 19 made of the high-performance insulation material, which is, as mentioned, either Microtherm 1000R or Microtherm 1200 in this case.

The curve 31 shows the thermal inertia for Microtherm 1000R which in turn necessarily breaks off at the point 32 at a layer thickness of 30 mm. The curve 33 shows the thermal inertia for Microtherm 1000R which in turn necessarily breaks off at the point 34 at a layer thickness of 60 mm. It is noted that the thermal inertia initially increases as the layer thickness of the high-performance insulation increases, because the operating temperature in the dense layer of high-temperature insulation increases as a result of the better thermal insulation. The inertia would only decrease again if the layer thickness of the high-performance insulation were to continue to increase, which is not feasible in light of the maximum operating temperature of the same.

FIG. 2a schematically shows a cross-section through a cylindrical section 40 insulated according to the invention with the dimensions and the operating temperature of the section 10 of FIG. 1b. The insulating area 41 is visible, which comprises an inner layer 42 made of a high-temperature insulation material and an outer layer made of a high-performance insulation material, the layers in the shown embodiment again consisting of Zircar ZYFB-3 and Microtherm 1000R, respectively.

Situated between the layers 41,42 is a cooling channel 44, in which a cooling medium heated by the inner insulating layer 42 circulates during the operation of the receiver, the cooling channel 44 in turn being insulated vis-à-vis the surroundings by the outer layer 43. The cooling channel 44, the cooling medium and its operating parameters such as flow rate etc. are then set, i.e. selected, in such a manner that, during the operation of the receiver 4 (FIG. 1a), the outer insulating layer 43 is not heated beyond its operating temperature, 1000° C. in the case of Microtherm 1000R. One skilled in the art can determine the materials and operating parameters that are appropriate in specific cases.

The thus heated cooling medium can then be conducted to a consumer where it releases its heat, so that the heat from the insulating area 41 is utilized, which in turn accordingly increases the efficiency of the receiver 4 and of the respective process unit.

It is possible by this means to augment the outer layer 43 and/or to reduce the inner layer 41, depending on the specific case, which decreases the thermal inertia of the insulation.

On the whole, the recuperation of the heat that is conducted away from the insulation does not reduce or only slightly reduces the efficiency of the process unit, while improving its thermal inertia, which increases the overall efficiency of the process unit. With an arrangement according to FIGS. 3a and 3b, it is even the case that, in addition to the desired reduction in thermal inertia, the efficiency of the process unit is considerably increased: the graph of FIG. 2b shows by way of the curve 51 the heat loss through the insulation according to the invention, which is lower than the heat loss with a conventional insulation shown by the curve 21. Cf. the description below pertaining to FIGS. 2b to 3b in this regard.

A method for insulating a process unit provided with an insulating area for curbing a heat flow from a hot side to a cold side of the insulating area results, wherein the insulating area is cooled at a site having a temperature that is lower than that of the hot side, the heat absorbed by a cooling medium is transported out of the insulating area and supplied as recuperated operational heat to a consumer of heat. A process unit with an insulating area for carrying out this method comprises a cooling arrangement which is configured in such a manner that it conducts heat out of the insulating area during the normal operation of the process unit.

It is noted here that the insulation according to the invention differs from emergency cooling systems, e.g., in that it conducts heat that is generated continuously during normal operation out of the insulating area.

The insulating area is preferably configured to comprise a plurality of layers, wherein two adjacent layers are provided, the layer upstream in relation to the heat flow having a higher thermal conductivity coefficient λ and the layer downstream in relation to the heat flow having a lower thermal conductivity coefficient λ, and wherein the cooling medium absorbs and removes heat between these layers. In other words, the insulating area is preferably configured to at least partially comprise a plurality of layers, wherein two adjacent layers are provided, the layer upstream in relation to the heat flow having a higher maximum operating temperature and the layer downstream in relation to the heat flow having a lower maximum operating temperature, and wherein the cooling medium absorbs and removes heat between these layers. The cooling channel 44 represents a heat exchanger that absorbs heat from the inner insulating layer 42 and transfers it to the cooling medium. In specific cases, one skilled in the art can configure the heat exchanger appropriately and provide an arrangement different from the ring channel shown in FIG. 2a, e.g. an annular tube bundle. The process unit thus preferably comprises a cooling arrangement provided with a heat exchanger that is arranged so as to be operational between the consecutive layers so as to absorb heat from the transition zone between the layers during operation. The cooling arrangement is further preferably configured in such a manner that, during operation, the layer (43,84) arranged next to it downstream in the heat flow is at its operating temperature.

A cooling channel formed from tubes has the advantage that, when the flow rate of the cooling medium is adapted accordingly, an essentially laminar flow forms in the tubes, which in turn results in a convective cooling of the contiguous insulation layers and a heat transfer coefficient of the cooling channel that is accordingly independent of the flow rate of the cooling medium (provided that the laminar flow is maintained, i.e. that the flow rate does not exceed a corresponding limit). In the case of an absorptive gas (cf. description below), the heat transfer coefficient is also independent of the flow rate without a laminar flow when the ratio of the heat absorbed by the cooling medium in the cooling channel by absorption to the total heat absorbed in the cooling channel by absorption and convection is equal to or greater than 0.5 or preferably equal to or greater than 0.7, particularly preferably equal to or greater than 0.8.

This renders possible a simplified control of the cooling during operation.

FIG. 2b shows a graph 50 regarding the thermal conditions in a process unit insulated according to the invention, which is configured as a receiver according to FIG. 2a. The heat flow in kW/m is plotted on the vertical axis; the thickness of an outer layer 43 (FIG. 2a) made of Microtherm 1000R is plotted on the horizontal axis. The graph is based on a width of the cooling channel 44 (FIG. 2a) of 20 mm and a cooling medium of water vapour at 800 K.

The graph 50 includes the curve 21 from FIG. 1c, which shows the heat flow out of the insulated area 17 with a conventional insulation, in other words the heat loss. The point 22 shows, as mentioned above, the maximum possible thickness of the outer layer 18 made of Microtherm 1000R in this case.

For comparative purposes, the curve 51 shows the heat loss on the outside of the outer layer 43 made of Microtherm 1000R. The minimum heat loss with the insulation according to the invention is visible at the point 52 and is approx. 10% of the heat loss of the conventional insulation, cf. point 22.

The curve 53 shows the heat absorbed by the cooling medium in the channel 44—which is not lost but supplied to a consumer, cf. also the description relating to FIG. 3 in this regard.

The curve 54 shows the heat flow through the inner insulation layer 42.

FIG. 2c shows a graph 60, wherein the thermal inertia, i.e. the amount of heat in kWh/m required to heat the insulation, is plotted on the vertical axis and the thickness of the outer layer 43 is once again plotted on the horizontal axis (FIG. 2a).

The curve 61 shows the energy required for heating the conventional insulation according to FIG. 1b to operating temperature, while the curve 62 shows the energy required for heating the insulation according to the invention according to FIG. 2a to operating temperature, which is relevantly lower.

FIG. 3a schematically shows a process unit configured as a receiver 70, as can be employed in a solar tower power plant according to FIG. 1a and according to FIG. 3b in order to recuperate the heat from the insulation configured according to the invention.

The receiver 70 includes a heating area 71, with an optical aperture 72, for example a quartz window, and an absorber 73, wherein, between the quartz window 72 and the absorber 73, an absorption area 74 is provided, through which the heat-transporting medium flows from right to left in accordance with the illustrated arrows, i.e. toward the absorber 73. To this end, the transport apparatus 75 includes inlet nozzles 76 for heat-transporting medium with the temperature Tᵢₙ arranged around the quartz window 72 (and connected to the line 8, cf. FIG. 1), said inlet nozzles 76 leading into the absorption area 74, and a central outlet nozzle 77 for heat-transporting medium with the temperature T₀ arranged behind the absorber 73 (the outlet nozzle leading into the line 6, cf. FIG. 1).

The absorber 73 can be configured as a reactor element by means of which the depicted arrangement is converted from a receiver into a receiver/reactor, i.e. an arrangement in which concentrated solar radiation, for example from a solar tower power plant, is used for carrying out a chemical reaction, herein preferably the production of syngas.

For this purpose, the absorber 73 configured as a reactor then includes, for example, a reducible and oxidizable material for a reduction and oxidation process, preferably CeO₂, which can be respectively reduced at higher temperatures and oxidized in the presence of an oxidizing gas. Other materials such as, for example, cerium dioxide (CeO₂), doped CeO₂ or perovskite can be specified by one skilled in the art for specific cases.

The absorber 73 is further configured as a black-body radiation arrangement, i.e. it has a surface 73′ arranged in the path of the incident solar radiation 78 which absorbs this radiation and which is configured in such a manner that the absorber 73 is heated to a serviceable temperature as a result of the incident solar radiation 78 striking its surface 73′ and subsequently emits corresponding black-body radiation 3′ (essentially infra-red radiation) via its surface 73′ into the absorption area 74. The term black-body radiation is used here to designate radiation emitted by the absorber 73 as a result of its temperature, as opposed to sunlight 78 reflected by the same. The temperature of the absorber 73 is greatly increased through the absorption of the sunlight 78 and can lie in a range of, for example, 1000 K to over 2000 K, depending on the design of the receiver 73 in the specific case and on the materials used. In principle, however, the operating-temperature range of the receiver does not have an upper limit, but rather depends on the desired temperatures and available materials.

The absorber 73 thus emits its heat output in the form of black-body radiation (Infra-red radiation) into the absorber area 74, provided that, in the case of a receiver-reactor, it is not consumed for the endothermic reaction of reduction and the formation of syngas during oxidation. The energy that is accordingly required is supplied by the solar radiation 78.

A gas or gas mixture that absorbs infra-red radiation is further used as the heat-transporting medium, said gas or gas mixture absorbing the black-body radiation of the absorber 73 while in the heating area 71 and being heated accordingly with regard to Tₒᵤₜ. A heteropolar gas, preferably one of the gases CO₂, water vapour, CH₄, NH₃, CO, SO₂, SO₃, HCl, NO and NO₂ or a mixture thereof can be used as the infrared-absorbing gas.

The use of such gases ultimately results in a greenhouse effect that can be utilized or is utilized by the receiver-reactor according to the invention, as these gases are highly transparent for visible light which thus substantially reaches the absorber, yet slightly to hardly transparent for the infra-red radiation of the absorber, so that they are thus heated absorptively to Tₒᵤₜ before reaching the absorber. It is noted here that real gases do not absorb visible light or infra-red radiation equally across all frequencies nor are they equally transparent for visible light or infra-red radiation across all frequencies, but rather that these characteristics vary considerably in particular in frequency bands specific to a gas. Moreover, absorption decreases with increasing distance from the source of radiation. The characterizations “highly transparent” and “slightly to hardly transparent” are consequently used in the foregoing in relation to the absorption or transparency of radiation.

A decisive parameter is thus the absorptivity a of the heat-transporting gas, which can be measured by means of experimentation, calculated from spectral line values from molecular spectroscopic databases (e.g. HITEMP2010) or determined approximately from emissivity charts in accordance with Hottel's rule.

It is noted here that, in addition to the visible light with no infra-red frequencies, the sunlight naturally also includes such infra-red frequencies. These infra-red frequencies are absorbed in accordance with the invention directly by the heat-transporting fluid in the absorption area, their energy thus being utilized with essentially no losses, as the back radiation is in turn absorbed by the incoming fluid.

Finally, in addition to the use of an infrared-absorbing gas or gas mixture, the absorption area 71 is configured and the mass flow of the heat-transporting medium is determined in a such a manner that preferably essentially the entire black-body radiation of the absorber 73 is absorbed by the heat-transporting medium, i.e. the back radiation of the absorber 14 through the aperture 72 is substantially absorbed by the gas.

The back radiation of the absorber 73 is the black-body radiation of the same that lies on a path running through the aperture 72 and that is consequently—if it is not absorbed—radiated into the surrounding area, thus reducing the efficiency of the receiver-reactor. A special zone, the absorption area 71, is provided, in combination with the absorber configured as a reactor, through the illustrated receiver in order to eliminate these losses in efficiency within the framework of a viable geometry for a receiver or receiver/reactor. The path running through the aperture does not have to lie in a straight line, but rather also comprises black-body radiation of the absorber 73 reflected by the walls of the absorption area.

Such an absorption of back radiation of the absorber 73 presupposes, first, that the absorption area 71 is long enough and, second, that the mass flow of the heat-transporting fluid is sufficient to maintain a temperature profile in the absorption area 71 so that the temperature at the site of the aperture is only marginally over Tᵢₙ which would no longer be the case after a period of time, for example, in the event of a standstill of the heat-transporting fluid. Such a receiver can have a height and a diameter, respectively, of 15.95 m; it is then suitable to receive the solar radiation of a field of heliostats according to FIG. 1a, wherein the heat-transporting fluid is essentially heated by absorption.

Three advantages result from this use of an infrared-absorbing gas:

First, radiation losses from the optical aperture due to back radiation of the black-body radiation are predominantly or essentially completely avoided according to the invention. This back radiation reduces the efficiency of a conventional receiver (and thus of a receiver/reactor) appreciably.

Second, the heat of the black-body radiation of the absorber can be utilized directly in the heat-transporting fluid and is available for a flexible usage, cf. also the following description in this regard.

Third, the heating of the heat-transporting medium to Tₒᵤₜ requires neither significant expenditure in terms of design nor a toleration of corresponding flow losses, as is the case with conventional receivers working predominantly by convection. The corresponding problems (constructional expenditure, flow losses) in volumetric receivers with spatially configured absorbers with a complicated structure do not apply. This applies in particular with regard to the absorption area, as, for a black-body radiation into the absorption area that is as intensive as possible, high temperatures of the absorber as well as of the side walls of the absorption area are advantageous so that no cooling means of any kind is required there, in particular cooling channels as provided in receivers according to the prior art—either cooling channels in the walls or cooling channels in the absorber ensuring a maximum convection.

Length and diameter of the absorption chamber 74 are both 15.96 m. A sufficient length of the absorption chamber for an almost entire absorption of the black-body radiation of the absorber is thus provided. The absorber can be configured, for example, as a simple plate in this case so that the receiver-reactor can be readily manufactured as a low-cost solution in terms of its design. In this case, the surface of the absorber radiating into the absorption chamber preferably includes a reducible/oxidizable material.

The diameter of the optical aperture 72 is 11.28 m, which is thus suitable for receiving the radiation of the field of heliostats 2 (FIG. 1a), yet with a surface area of 100 m² that is only half as large as the surface area of 200 m² of the absorber 14 so that the back radiation of the heat-transporting fluid with the temperature Tᵢₙ is also reduced accordingly.

The absorber 73 is made of CeO₂; the weight of the receiver-reactor is 144 t. The radiation flux is 1200 kW/m2 through the optical aperture 72 and 600 kW/m² at the absorbing surface 14′ (which has double the surface area in comparison with the aperture 72).

Water vapour is used as the heat-transporting and infrared-absorbing fluid, wherein its temperature Tᵢₙ is 1000 K. This temperature is illustrative of an industrial process associated with the receiver-reactor taking place at, for example, 900 K, cf. the consumer 7 of FIG. 1a. The temperature Tₒᵤₜ of the water vapour at the absorber is 1800 K, which, for example, is also sufficient for the production of syngas.

FIG. 3b shows schematically a section of a solar tower power plant 1 (FIG. 1a) with a receiver 80, which is insulated according to the invention, i.e. comprises an insulating layer 81 with a cooling channel 82, which in turn lies between an inner high-temperature insulation layer 83 and an outer high-performance insulation layer 84. This arrangement corresponds to the one shown in FIG. 2a. A transport arrangement for the heat-transporting fluid—here via the line 6 for heated heat-transporting fluid, the consumer 7 and the line 8 for cold heat-transporting fluid—generally corresponds to the arrangement according to FIG. 1a.

The cooling channel 82 has an inlet nozzle 85 upstream and an outlet nozzle 86 downstream. The heat-transporting fluid is used as the cooling medium here, wherein cold heat-transporting fluid flows into the inlet nozzle via the line 87, through the insulation along the length of the heating area 71 of the receiver, where it is heated, to the outlet nozzle 86, where it enters a line 88, which in turn leads via an inlet 88 provided in the receiver 80 into the absorption area 74 of the latter.

The cold heat-transporting fluid flowing from the optical aperture 72 of the receiver 80 toward the absorber 73 is continuously heated by absorption from Tᵢₙ, at the optical aperture 72, to T₀, at the site of the absorber 73, cf. description regarding FIGS. 1a and 3a. Accordingly, there is a site in the heating area 71 where the temperature of the continuously heated fluid flowing through it corresponds to the temperature of the fluid discharged from the outlet nozzle 86. The inlet 88 is provided at this site. In particular cases, one skilled in the art can provide a plurality of inlets for different operating loads of the receiver 80. Alternatively, it is of course possible to provide a separate cooling circuit for the insulation, which has its own consumer.

This results in a method in which a heat-transporting fluid to be heated by the receiver is preferably used as the cooling medium, which fluid, after heating in the insulating area, is preferably conducted into the receiver. To this end, an arrangement according to the invention preferably provides that the receiver comprises a transport arrangement for a heat-transporting fluid which is configured in such a manner that, during operation of the receiver, the heat-transporting fluid is heated by the receiver, and wherein the transport arrangement is further configured in such a manner that it transports cold heat-transporting fluid through the cooling unit before conducting the same into the receiver.

As a result, an arrangement such as the one shown illustratively in FIG. 3b can significantly reduce heat losses in comparison with a conventional insulation, cf. the point 52 in the graph 50 of FIG. 2b in relation to the point 22, as the heat removed from the insulation is simultaneously recuperated, which is essentially entirely accomplished in the case of the arrangement shown in FIG. 3b. Moreover, the thermal inertia is also significantly reduced, which also increases the efficiency of the arrangement insulated according to the invention.

To this end, the process unit is preferably configured as a receiver, the operating temperature of which is equal to or higher than 1000 K, preferably 1500 K, particularly preferably 1800 K, most preferably 2000 K. However, as mentioned above, the process unit can be configured in a different manner, for example as a high-temperature pipe the operating temperature of which is equal to or higher than 1000 K, preferably 1500 K, particularly preferably 1800 K, most preferably 2000 K, and which is further preferably a pipe for a heat-transporting fluid heated by a receiver.

FIG. 3c schematically shows a section of an embodiment similar to the one shown in FIG. 3b, wherein, however, the arrangement of the line 8 for the heat-transporting fluid has been modified. The line 8 leads directly into the inlet nozzle 85, and the cooling channel 82 leads directly into the absorption area 74. As a result of its high mass flow, the heat-transporting fluid is heated only slightly in the insulation, i.e. it is only heated negligibly above Tᵢₙ, whereby the theoretical slight increase in back radiation through the optical aperture 72 is of no significance for efficiency.

1. A method for insulating a process unit provided with an insulating area for curbing a heat flow from a hot side to a cold side of the insulating area, the method comprising:
the insulating area is cooled at a site having a temperature that is lower than that of the hot side; and
the heat absorbed by a cooling medium is transported out of the insulating area and supplied as recuperated operational heat to a consumer of heat.

2. The method according to claim 1, wherein the insulating area is configured to comprise a plurality of layers, wherein two adjacent layers are provided, the layer upstream in relation to the heat flow having a higher conductivity coefficient λ and the layer downstream in relation to the heat flow having a lower thermal conductivity coefficient λ, and wherein the cooling medium absorbs and removes heat between these layers.

3. The method according to claim 1, wherein the insulating area is configured to at least partially comprise a plurality of layers, wherein two adjacent layers are provided, the layer upstream in relation to the heat flow having a higher maximum operating temperature and the layer downstream in relation to the heat flow having a lower maximum operating temperature, and wherein the cooling medium absorbs and removes heat between these layers.

4. The method according to claim 1, wherein the process unit is configured as a receiver, the operating temperature of which is equal to or higher than 1000 K.

5. The method according to claim 1, wherein the process unit is configured as a high-temperature pipe, the operating temperature of which is equal to or higher than 1000 K.

6. The method according to claim 1, wherein a heteropolar gas that absorbs infrared radiation is used as the cooling medium, preferably one or a mixture of the gases CO₂, water vapour, CH₄, NH₃, CO, SO₂, SO₃, HCl, NO, and NO₂, particularly preferably a mixture with water vapour and CO₂.

7. The method according to claim 1, wherein the ratio of the heat absorbed by the cooling medium in the cooling channel by absorption to the total heat absorbed in the cooling channel by absorption and convection is equal to or greater than 0.5.

8. The method according to claim 1, wherein a heat-transporting fluid to be heated by the receiver is used as the cooling medium, which fluid, after heating in the insulating area, is preferably conducted into the receiver.

9. A process unit with an insulating area for carrying out the method according to claim 1, comprising a cooling arrangement which is configured to conduct heat away from the insulating area during the normal operation of the process unit.

10. The process unit according to claim 9, wherein the insulating area is at least partially constructed with a plurality of layers and comprises an insulation material with a different thermal conductivity coefficient λ in at least two consecutive layers in the direction of the heat flow generated during normal operation, wherein the layer arranged upstream in the heat flow has the higher thermal conductivity coefficient λ.

11. The process unit according to claim 9 wherein the insulating area is at least partially constructed with a plurality of layers and comprises an insulation material having a different maximum operating temperature in at least two consecutive layers in the direction of the heat flow generated during normal operation, wherein the layer arranged upstream in the heat flow has the higher operating temperature.

12. The process unit according to claim 10, wherein the cooling arrangement is provided with a heat exchanger that is arranged so as to be operational between the consecutive layers so as to absorb heat from the transition zone between the layers during operation.

13. The process unit according to claim 12, wherein the cooling arrangement is configured in such a manner that, during operation, the layer arranged next to it downstream in the heat flow is at its operating temperature.

14. The process unit according to claim 9, wherein the latter is configured as a receiver.

15. The process unit according to claim 14, wherein the receiver comprises a transport arrangement for a heat-transporting fluid which is configured in such a manner that, during operation of the receiver, the heat-transporting fluid is heated by the receiver, and wherein the transport arrangement is further configured in such a manner that it transports cold heat-transporting fluid through the cooling unit before conducting the same into the receiver.

16. The process unit according to claim 9, wherein the latter is configured for an operating temperature of 1000 K or more.

17. The process unit according to claim 9, wherein the latter is configured as a pipe for a hot medium with an operating temperature of 1000 K or more.
